(19) United States
(12) Patent Application Publication
(10) Pub. No.: US 2006/0003747 A1
(43) Pub. Date: Jan. 5, 2006

(54) Periodic parameter control command for a wireless mobile device

(76) Inventor: Mikolaj Kolakowski, Reda (PL)

Correspondence Address: BUCKLEY, MASCHOFF, TALWALKAR LLC, 5 ELM STREET, NEW CANAAN, CT, 06840, US

(21) Appl. No.: 10/858,550

(22) Filed: Jun. 1, 2004

(51) Int. Cl. H04Q 7/20

(52) U.S. Cl. 455/414.1; 455/456.4

(57) ABSTRACT

According to some embodiments, a periodic parameter control command is broadcast to a wireless mobile device.

### BACKGROUND

A wireless mobile device may be brought into, and used in, different types of locations. For example, a user may bring a wireless telephone to a shopping mall or a theater. Note that a mobile device may be able to operate in a number of different modes. For example, a wireless phone might generate an audible sound if a telephone call is received when it is operating in one mode but remain silent when operating in another mode.

In some cases, it may be inappropriate for a mobile device to operate in a particular mode given the nature of its current location. For example, it might not be appropriate to have a wireless telephone generate an audible sound when it is in a theater or museum. Although a user might manually adjust the mode of a mobile device (e.g., by switching a wireless telephone to a “silent” mode), some users may forget or be unaware that a certain mode is not appropriate.

In addition, it may be appropriate for a mobile device to operate in one mode at a location under some circumstances, and yet be inappropriate for it to operate in that mode at the same location under other circumstances. For example, it might not be appropriate to have a wireless telephone generate an audible sound in a meeting room when there is currently a meeting taking place, and yet appropriate to do so when there is no meeting. As another example, it might not be appropriate for a user's laptop to generate sound when he or she is participating in a teleconference, and yet it may be appropriate to do so when he or she is not.

### BRIEF DESCRIPTION OF THE DRAWINGS

FIG. 1 is a block diagram of a system according to some embodiments.

FIG. 2 is a flow chart of a mobile device controller method according to some embodiments.

FIG. 3 is a flow chart of a mobile device method according to some embodiments.

FIG. 4 is a timeline according to some embodiments.

FIG. 5 is a block diagram of a system according to some embodiments.

FIG. 6 is a block diagram of a mobile device controller system according to some embodiments.

FIG. 7 is a flow chart of a mobile device controller method according to some embodiments.

FIG. 8 is a block diagram of a mobile device system according to some embodiments.

FIG. 9 is a flow chart of a mobile device method according to some embodiments.

### DETAILED DESCRIPTION

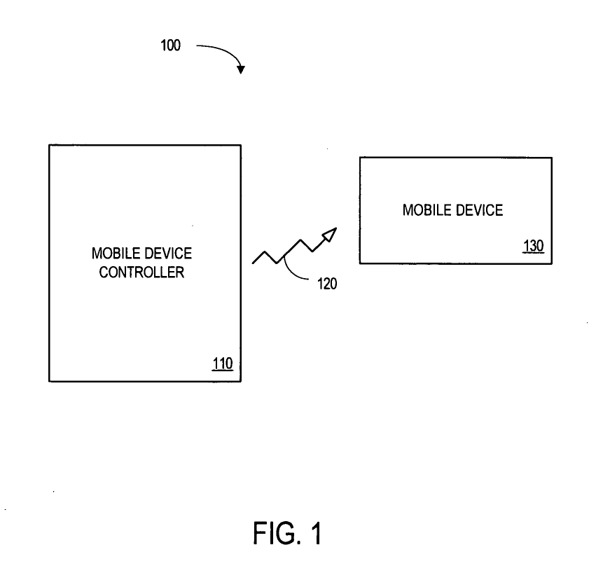

FIG. 1 is a block diagram of a system 100 according to some embodiments. In particular, a mobile device controller 110 may transmit a wireless message 120 to a mobile device 130. The message 120 may be, for example, transmitted using a Radio Frequency (RF) or an Infra-Red (IR) transmitter associated with the mobile device controller 110. The message 120 may be transmitted using any wireless protocol, including third generation (3G) wireless, Global System for Mobile (GSM), and/or Bluetooth communications. By way of example, the message 120 may be transmitted via a Wireless Local Area Network (WLAN) that operates in accordance with an Ethernet protocol and/or a Code-Division Multiple Access with Collision Avoidance (CDMA/CA) protocol such as the one defined by Institute of Electrical and Electronics Engineering (IEEE) specification number 802.11g (2003).

The mobile device controller 110 might be, for example, a stationary device such as a desktop Personal Computer (PC) or wired telephone. As another example, the mobile device controller 140 might be a device mounted at or located in a theater, museum, library, or meeting room.

The mobile device 130 may be any wireless device, such as a Personal Digital Assistant (PDA), a handheld or laptop computer, or a wireless telephone, pager, or beeper. According to some embodiments, the mobile device 130 locally stores a parameter that controls the operation of the mobile device 130. The mobile device 130 might, for example, generate audible sounds when the parameter has one value and suppress such sounds when the parameter has another value. As other examples, the parameter might prevent the mobile device 130 from exchanging information (e.g., a wireless telephone might be prevented from placing a telephone call, transmitting text messages, or capturing an image).

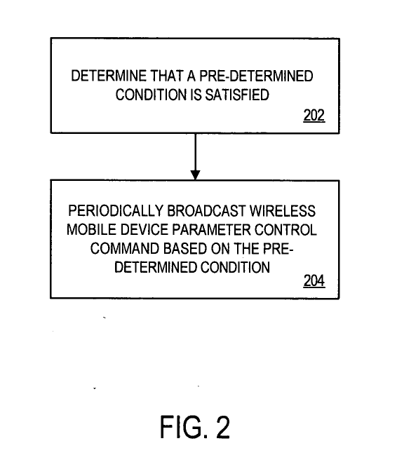

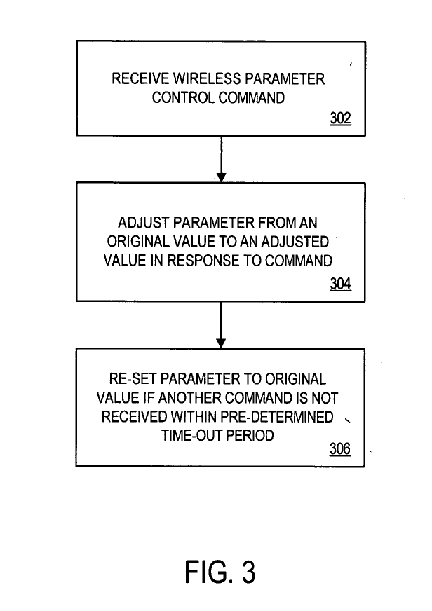

As described with respect to FIGS. 2 and 3, such a system may be used to prevent a mobile device from operating in a mode that is not appropriate given the location and/or the current circumstances.

FIG. 2 is a flow chart of a method that may be performed, for example, by the mobile device controller 110 described with respect to FIG. 1. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 202, it is determined that a pre-determined condition is satisfied. By way of example, the mobile device controller 110 might determine that a user has joined a teleconference using his or her desktop PC or wired telephone. Similarly, the mobile device controller 110 might determine that a meeting is currently taking place in a conference room or that a play is currently being performed in a theater. According to some embodiments, a condition may be an indication that the mobile device controller 110 has been installed at a location and/or has been activated (e.g., it is turned on).

At 204, a wireless mobile device parameter control command is broadcast on a periodic basis based on the pre-determined condition. For example, the mobile device controller 110 might wirelessly broadcast a parameter control command every two seconds when it determines that a user has joined a teleconference. According to some embodiments, the command includes an indication of a particular mobile device parameter and/or a value for that parameter. For example, the command might indicate that it is associated with the ability to place a telephone call and the value might indicate that such an ability should be suppressed. Note that a single command might include a number of different types of parameters and/or associated values.

The mobile device controller 110 may subsequently determine that the pre-determined condition is no longer satisfied. In this case, it can arrange for the wireless mobile device parameter control command to no longer be broadcast. For example, the mobile device controller 110 might stop broadcasting commands when it determines that a user is no longer participating in a teleconference.

FIG. 3 is a flow chart of a method that may be performed, for example, by the mobile device 130 described with respect to FIG. 1. At 302, the mobile device 130 receives a wireless parameter control command. For example the mobile device 130 might wirelessly receive a command that has been broadcast by the mobile device controller 110.

At 304, a parameter is adjusted from an original value to an adjusted value in response to the parameter control command. For example, the mobile device 130 might adjust a locally stored parameter such that it will no longer generate audible sounds.

At 306, the parameter is re-set to the original value if another parameter control command is not received within a pre-determined time-out period. For example, if no further command is received within three seconds, the mobile device 130 might re-set a parameter such that audible sounds will again be generated. If another command is received within the pre-determined time-out period, the mobile device 130 may instead arm a timer to begin a new time-out period.

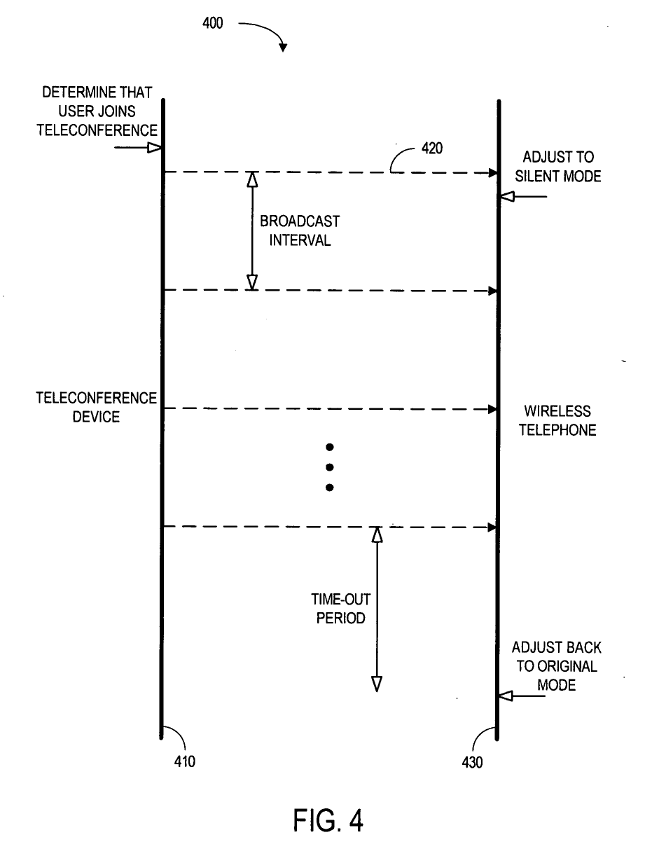

For example, FIG. 4 is a timeline 400 according to some embodiments. In particular, the timeline 400 illustrates a teleconference device 410 that is broadcasting commands 420 to a wireless telephone 430 (with events toward the top of the figure occurring before events toward the bottom of the figure). Initially, the teleconference device 410 determines that a user has joined a teleconference, and a command 420 is broadcast. The teleconference device 410 also arms a timer with a two second broadcast interval value.

The wireless telephone 430 receives the command and adjusts itself to operate in a silent mode. The wireless telephone 430 also arms a timer with a three second time-out period value. Note that because the timer in the teleconference device 410 was armed with a lower value it will therefore expire before the timer in the wireless telephone 430.

When the timer in the teleconference device 410 expires, the teleconference device 410 determines if the user is still participating in the teleconference. If so, another command 420 is broadcast and the teleconference device 410 re-arms the timer with the two second broadcast interval value.

When the wireless telephone 430 receives the new command, it re-arms its timer with the three second time-out period value.

At some point, the broadcast interval timer in the teleconference device 410 will expire, and the teleconference device 410 will determine that the user is no longer participating in a teleconference. In this case, the teleconference device 410 stops broadcasting commands 420.

Because no commands 420 are being received, the timer in the wireless telephone 430 will eventually expire. The wireless telephone 430 may then adjust itself back to an original mode of operation (e.g., and again generate audible sounds).

Note that the command 420 may be broadcast such that it will only be received by wireless telephones 430 within a pre-determined distance from the teleconference device 410 (e.g., within three meters). As a result, when a wireless phone 430 moves away from the teleconference device 410 it will stop receiving commands 420, and thus revert back to an original mode of operation (e.g., after three seconds).

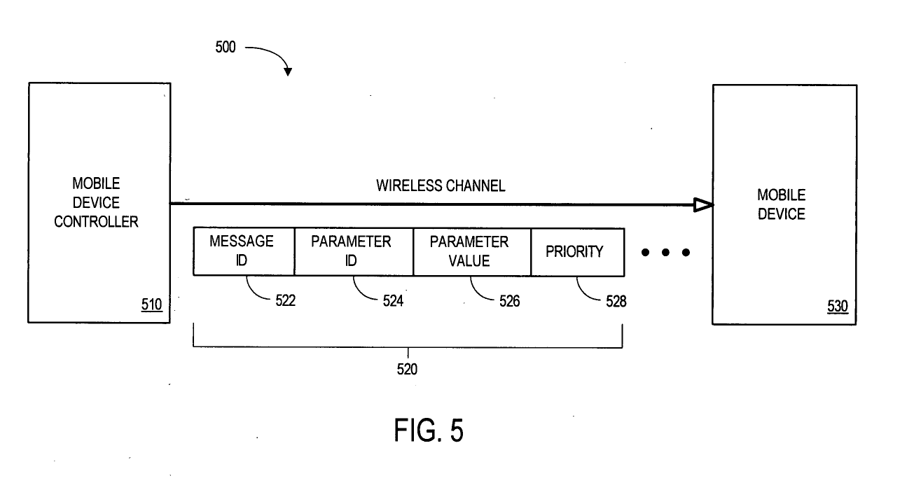

FIG. 5 is a block diagram of a system 500 according to some embodiments. In particular, a mobile device controller 510 transmits a message 520 to a mobile device 530 via a wireless channel (e.g., using an RF or IR message).

In this case, the command 520 includes a message identifier 522 that indicates that the message is a parameter control command. The command 520 also includes a parameter identifier 524 and a parameter value 526 that define the parameter to be adjusted and the value to which it should be set (e.g., set “Ability to Capture Images” to “disabled”).

According to this embodiment, the command also includes a priority indication 528. The priority indication 528 may be used, for example, when the mobile device 530 receives conflicting commands from different mobile device controllers 510. The priority indication 528 might also indicate whether a user should be allowed to manually over-ride a command and/or whether or not the command will apply to all mobile devices 530 and/or users. For example, a command preventing wireless telephones from making outgoing telephone calls might not apply to a wireless telephone operated by a doctor or police officer.

The command 520 might contain information in addition to or other than the information illustrated in FIG. 5. For example, the command 520 might include a rule that should be evaluated by the mobile device 530. As another example, the command 520 might include an indication of a time-out period value (e.g., to be used by the mobile device when arming a timer).

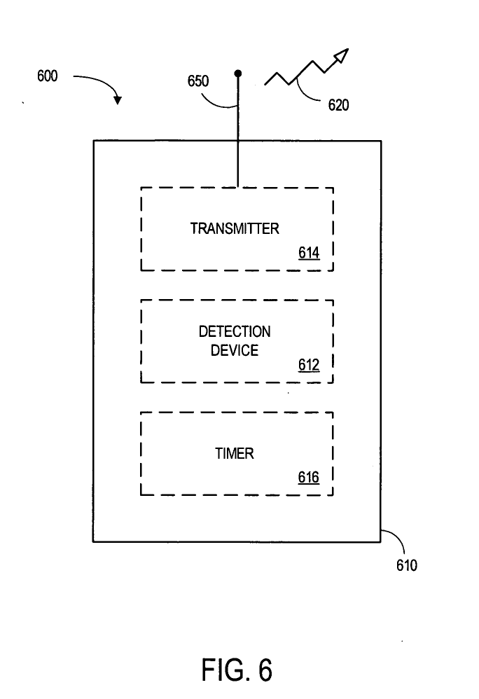

FIG. 6 is a block diagram of system 600 that includes a mobile device controller 610 with a detection device 612, a transmitter 614, and a timer 616. The detection device 612 may be, for example, hardware and/or software that determines if a pre-determined condition is satisfied (e.g., based on information local to the mobile device controller 610 or received from another device). The transmitter 614 may periodically transmit commands 620 when appropriate, including when the timer 616 expires. The system also includes an antenna 650, such as a uni-directional or multi-directional antenna, that may be used by the transmitter 614 to broadcast commands 620.

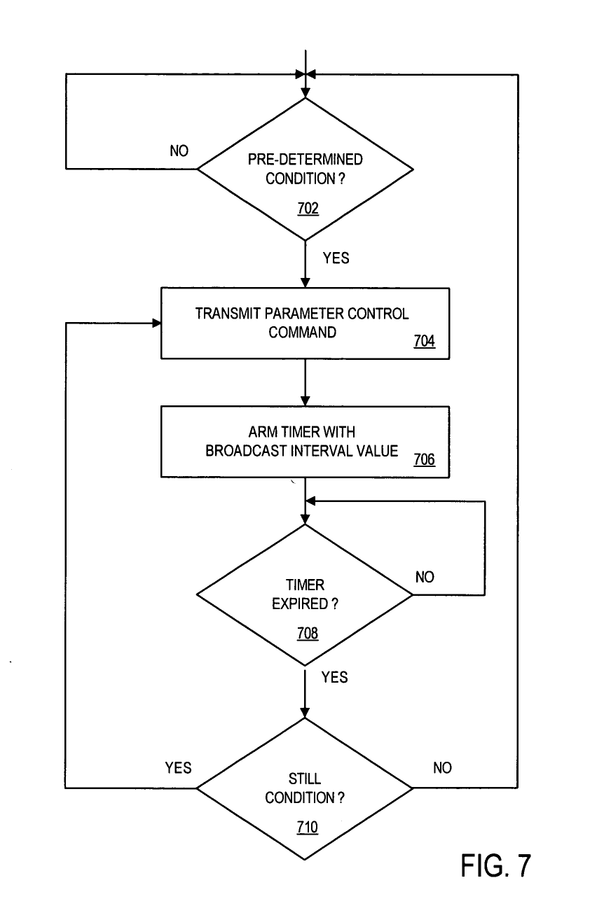

FIG. 7 is a flow chart of a method that may be associated with the system 600 illustrated in FIG. 6 according to some embodiments. When it is determined that a pre-determined condition is satisfied at 702, a parameter control command is transmitted at 704. For example, transmitter 614 might broadcast a command 620 when the detection device 612 determines that a user has joined a teleconference.

The timer 616 is then armed with a time-out period value at 706. When the timer 616 expires at 708, the detection device 612 determines if the pre-determined condition still exists. If not, no additional commands will be transmitted (e.g., until the condition again exists at 702). If the pre-determined condition does still exist at 710, another command 620 is transmitted at 704 and the timer 616 is re-armed with the broadcast interval value at 706.

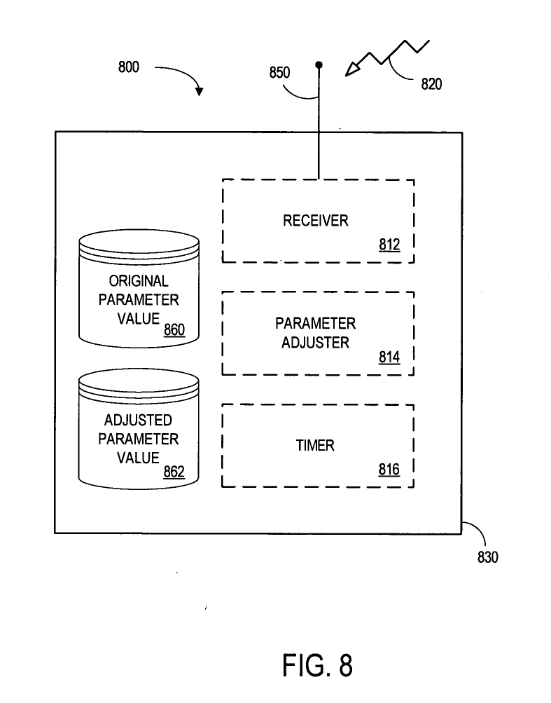

FIG. 8 is a block diagram of system 800 that includes a mobile device 830 with a receiver 812, a parameter adjuster 814, and a timer 616. The receiver 812 may periodically receive wireless commands 820 via an antenna 850 (e.g., a uni-directional or multi-directional antenna). When a command 820 is received, the parameter adjuster 814 stores an original parameter value 860 (e.g., a value associated with the mode of the mobile device 830 when the first command 820 was received) and creates an adjusted parameter value 862. A timer 816 is also armed with a time-out period value. If another command 820 is received before the timer 816 expires, the timer 816 is re-armed with the time-out period value. If the timer 816 eventually expires, the parameter adjuster 814 retrieves the original parameter value 860 and the mobile device 830 will revert to an original mode of operation.

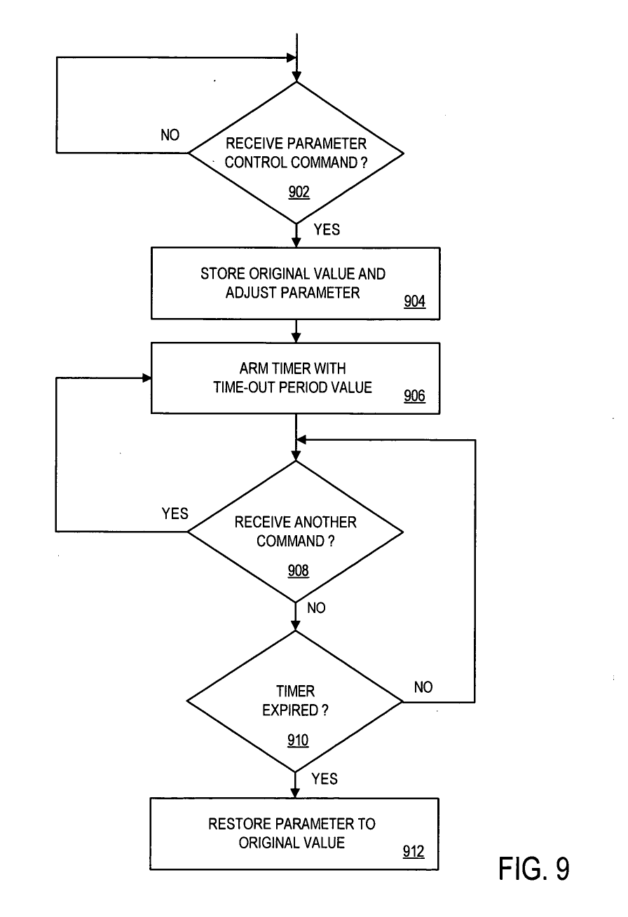

FIG. 9 is a flow chart of a method that may be associated with the system 800 illustrated in FIG. 8 according to some embodiments. When a parameter control command 820 is received by the receiver 812 at 902, the original parameter value 860 is stored and the mobile device 830 begins to operate in a mode associated with the adjusted parameter value 862 at 904. The timer 816 is also armed with a time-out period value at 906. When another command 820 is received by the receiver 812 at 908, the timer 816 is re-armed with the time-out period value.

When no other commands 820 are received and the timer 816 expires at 910, the original parameter value 860 is retrieved and the mobile device 830 reverts to an original mode of operation at 912 (e.g., the mode it was operating in before receiving commands 820).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although embodiments have been described with respect to a single mobile device controller and a single mobile device, note that a mobile device controller might broadcast a command that can be understood by different types of devices (e.g., wireless camera phones and laptop computers). In other cases, different commands may be broadcast for different devices. Also note that different types of commands may be received by a mobile device (e.g., one command preventing incoming telephone calls and separate command allowing outgoing telephone calls only to “911”). In this case, a mobile device may arm multiple timers.

According to some other embodiments, a mobile device might transmit a response confirming that a parameter has been adjusted or indicating that the parameter will not be adjusted.

Although some embodiments have been described with respect to a stationary mobile device controller sending commands to a mobile device, according to some embodiments a first mobile device may broadcast commands that are received by a second mobile device (e.g., one wireless telephone might prevent another wireless telephone from ringing). As still another example, a mobile device may transmit commands that are received by a stationary device (e.g., a wireless telephone might mute a desktop PC).

Moreover, although certain situations have been described herein as examples, the ability to externally set parameters for a wireless mobile device as described herein may be used in any other circumstances. For example, a mobile device controller might prevent telephone calls from being made in an airplane during take-off and landing.

The several embodiments described herein are solely for the purpose of illustration. Persons skilled in the art will recognize from this description other embodiments may be practiced with modifications and alterations limited only by the claims.

What is claimed is:

1. A method, comprising:
determining that a pre-determined condition is satisfied; and
periodically broadcasting a wireless mobile device parameter control command based on the pre-determined condition.

2. The method of claim 1, wherein said determining is performed by at least one of: (i) a stationary device, (ii) a telephone, and (iii) a personal computer.

3. The method of claim 1, wherein the parameter control command is associated with at least one of: (i) a wireless telephone, (ii) a portable computer, and (iii) a pager.

4. The method of claim 1, wherein said broadcasting is associated with at least one of: (i) a radio frequency broadcast, (ii) an infra-red broadcast, (ii) a wireless local access network, (iv) a Bluetooth communication, and (v) an 802.11 protocol.

5. The method of claim 1, wherein the pre-determined condition is associated with at least one of: (i) a telephone call, (ii) a teleconference, (iii) a location.

6. The method of claim 1, wherein the parameter control command includes at least one of: (i) an indication of a mobile device parameter, and (ii) a value.

7. The method of claim 6, wherein the parameter control command further includes a priority indication.

8. The method of claim 6, wherein the parameter control command further includes a time-out period indication.

9. The method of claim 1, wherein said broadcasting includes:
arming a timer with a broadcast interval;
broadcasting the command when the timer expires; and
if it is determined that the pre-determined condition is still satisfied, re-arming the timer with the broadcast interval.

10. The method of claim 1, further comprising:
determining that the pre-determined condition is no longer satisfied; and
arranging for the wireless mobile device parameter control command to no longer be broadcast.

11. An article, comprising:
a storage medium having stored thereon instructions that when executed by a machine result in the following:
determining that a pre-determined condition is satisfied, and
periodically broadcasting a wireless mobile device parameter control command based on the pre-determined condition.

12. The article of claim 11, wherein the pre-determined condition is associated with at least one of: (i) a telephone call, (ii) a teleconference, (iii) a location.

13. The article of claim 11, wherein the parameter control command includes a mobile device parameter, a priority indication, and a time-out period indication.

14. An apparatus, comprising:
a detection device to determine that a pre-determined condition is satisfied; and
a transmitter to periodically broadcast a wireless mobile device parameter control command based on the pre-determined condition.

15. The apparatus of claim 14, further comprising a timer to determine when the parameter control command is to be broadcast.

16. A method, comprising:
determining that a time-out period has expired; and
periodically broadcasting a wireless mobile device parameter control command based on the determination.

17. The method of claim 16, wherein the parameter control command includes a mobile device parameter, a priority indication, and a time-out period indication.

18. A method, comprising:
receiving at a mobile device a wireless parameter control command;
adjusting a parameter from an original value to an adjusted value in response to the parameter control command; and
if another parameter control command is not received within a pre-determined time-out period, re-setting the parameter to the original value.

19. The method of claim 18, further comprising:
if another parameter control command is received within the pre-determined time-out period, re-arming a timer.

20. An apparatus, comprising:
a receiver to receive a wireless parameter control command;
a parameter adjuster to adjust a parameter from an original value to an adjusted value in response to the parameter control command and to re-set the parameter to the original value if another parameter control command is not received within a pre-determined time-out period.

21. The apparatus of claim 20, further comprising:
a timer to determine when the parameter is to be re-set.

22. A system, comprising:
a detection device to determine that a pre-determined condition is satisfied;
a transmitter to periodically broadcast a wireless mobile device parameter control command based on the pre-determined condition; and
a multi-directional antenna.

23. The system of claim 22, further comprising a timer to determine when the parameter control command is to be broadcast.

24. A system, comprising:
a receiver to receive a wireless parameter control command;
a parameter adjuster to adjust a parameter from an original value to an adjusted value in response to the parameter control command and to re-set the parameter to the original value if another parameter control command is not received within a pre-determined time-out period; and
a multi-directional antenna.

25. The system of claim 24, further comprising:
a timer to determine when the parameter is to be re-set.
